(19) United States
(12) Patent Application Publication
(10) Pub. No.: US 2009/0243544 A1
(43) Pub. Date: Oct. 1, 2009

(54) PROTECTIVE CIRCUIT FOR A PORTABLE ELECTRONIC DEVICE AND ITS SMART BATTERY AND THE PROTECTIVE METHOD THEREOF

(75) Inventor: Jin-En Liao, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/333,268

(22) Filed: Dec. 11, 2008

(30) Foreign Application Priority Data
Mar. 31, 2008 (TW) 97111765

(51) Int. Cl. H02J 7/00

(52) U.S. Cl. 320/128; 320/136

(57) ABSTRACT

A protective circuit for preventing a smart battery from being damaged is provided. The protective circuit includes a memory unit, disposed in the smart battery, for storing a preset value; a discharging unit disposed in a portable electronic device and coupled to the smart battery; and a control unit, coupled with the memory unit and the discharging unit, disposed in the portable electronic device. When the portable electronic device is connected to an external power supply, the control unit counts and updates the state of the preset value every preset time, and when the preset value reaches a specific value, the control unit controls the discharging unit to discharge the smart battery through the discharging unit.

### CROSS-REFERENCE TO RELATED APPLICATION

This application claims the priority benefit of Taiwan application serial no. 97111765, filed on Mar. 31, 2008. The entirety of the above-mentioned patent application is hereby incorporated by reference herein and made a part of this specification.

### BACKGROUND OF THE INVENTION

1. Field of the Invention

The invention relates to a portable electronic device and, more particularly, to a circuit which can protect a smart battery of a portable electronic device and a method thereof.

2. Description of the Related Art

With the development of the science and technology, various electronic products are developed toward the tendency of high speed, high efficiency and being light, slim, short and small. Thus, various portable electronic devices such as notebooks gradually enter the mainstream. To facilitate the carry and usage, a rechargeable battery is usually disposed in a portable electronic device to increase the practicability of the portable electronic device.

Generally, whether the rechargeable battery can be charged depends on the remaining capacity of the battery. If the remaining capacity meets the condition that the battery does not need to be charged (for example, the battery is 98% full) or the battery should stop being charged (for example, the battery is 100% full), the charge is stopped. However, the battery has properties of self-discharge (that is, the battery consumes electricity in it even when it is not used.) and degradation (that is, the capacity becomes less and less when the battery is used continuously). Therefore, if the battery is unused for a long time (for example, it is not discharged for a long time), since the gas gauge integrated circuit (IC) disposed in the battery still reports the capacity detected last time, or since the battery becomes degraded, the actual capacity of the battery is not the same to the reported capacity.

To solve the problem that the actual capacity is not the same to the reported capacity, the conventional method is that a user should perform a battery learn process regularly. Moreover, in performing the battery learn process, the user needs to perform the battery learn process through the user interface of the basic input output system (BIOS). However, a conventional computer system provides a BIOS user interface before the Windows operating system (OS) is loaded. Thus, the user cannot use the notebook at that moment, which is not convenient.

### BRIEF SUMMARY OF THE INVENTION

The invention provides a portable electronic device, a protective circuit for a smart battery and a method thereof. Thus, for the smart battery, a damage caused by being unused for a long time is avoided. For a user, the problem that he or she cannot use the portable electronic device when the smart battery is being discharged is avoided.

To achieve the above objectives, the invention further provides a protective circuit for preventing the smart battery from being damaged. The protective circuit includes a memory unit, a discharging unit, and a control unit. The memory unit for storing a preset value is disposed in the smart battery. The discharging unit is disposed in the portable electronic device and coupled to the smart battery. The control unit is disposed in the portable electronic device and coupled to the memory unit and the discharging unit. When the portable electronic device is connected to an external power supply (such as a commercial power), the control unit counts and updates the state of the preset value every preset time. When the preset value reaches a specific value, the control unit controls the discharging unit to discharge the smart battery through the discharging unit.

In another aspect of the invention, the invention provides a portable electronic device, which includes a smart battery and a protective circuit. The protective circuit further includes a memory unit, a discharging unit, and a control unit. The memory unit for storing a preset value is disposed in the smart battery. The discharging unit is disposed in the portable electronic device and coupled to the smart battery. The control unit is disposed in the portable electronic device and coupled to the memory unit and the discharging unit. When the portable electronic device is connected to an external power supply, the control unit counts and updates the state of the preset value every preset time. When the preset value reaches a specific value, the control unit controls the discharging unit to discharge the smart battery through the discharging unit.

In still another aspect of the invention, the invention provides a protection method for preventing the smart battery from being damaged. The method includes the following steps. Whether the operational power supply of the portable electronic device is provided by an external power supply is determined. When the operational power supply of the portable electronic device is provided by the external power supply, the control unit counts and updates the state of a preset value in a memory unit of the smart battery every preset time. When the preset value reaches a specific value, the smart battery is discharged.

In an embodiment of the invention, when the portable electronic device is connected to an external power supply, the operational power supply of the portable electronic device is provided by the external power supply.

In an embodiment of the invention, when the operational power supply of the portable electronic device is provided by the smart battery, the control unit stops counting and updating the state of the preset value and resets the preset value of the memory unit.

In an embodiment of the invention, when the preset value reaches a specific value, and the portable electronic device runs a Windows operating system, the control unit controls the discharging unit to discharge the smart battery through discharging unit.

In an embodiment of the invention, the control unit is an embedded controller (EC), and the memory unit is a nonvolatile memory such as an electrically erasable programmable read only memory (EEPROM) or a flash memory.

In an embodiment of the invention, if the preset value does not reach the specific value, the control unit continues counting and updating the state of the preset value every preset time.

In an embodiment of the invention, the portable electronic device further includes a charging unit. The charging unit is disposed in the portable electronic device and coupled with the smart battery and the control unit. When the portable electronic device is connected to an external power supply, and the charging unit charges the smart battery, the control unit stops counting and updating the state of the preset value and resets the preset value.

In an embodiment of the invention, the smart battery further includes a gas gauge integrated circuit (IC) for measuring the electric quantity of the smart battery.

In the invention, a memory unit is disposed in a smart battery, and when the smart battery does not provide power supply for the portable electronic device (notebook), the control unit counts and updates the preset value stored in the memory unit every preset time. When the preset value reaches a specific value, it means that the smart battery is not used for a long time. Thus, the discharging unit is controlled to discharge the smart battery through the discharging unit. Therefore, in the invention, the problem that the smart battery would be damaged when it is not used for a long time can be prevented. Moreover, in the invention, the smart battery is discharged through the discharging unit instead of using the portable electronic device itself as a discharge medium. Therefore, the user can continue using the portable electronic device, which is more convenient.

These and other features, aspects and advantages of the present invention will become better understood with regard to the following description, appended claims, and accompanying drawings.

### BRIEF DESCRIPTION OF THE DRAWINGS

FIG. 1 is schematic diagram showing an architecture of a portable electronic device in an embodiment.

FIG. 2 is a flow chart showing a protection method for preventing the smart battery from being damaged in an embodiment of the invention.

FIG. 3 is a flow chart showing a protection method for preventing the smart battery from being damaged in another embodiment of the invention.

FIG. 4 is a schematic diagram showing an architecture of a portable electronic device in another embodiment of the invention.

### DETAILED DESCRIPTION OF THE EMBODIMENT

One objective of the invention is to solve the problem that a battery may be damaged if it is unused for a long time. The technical characteristics are described in detail hereinbelow to provide for the person having ordinary skill in the art to refer to.

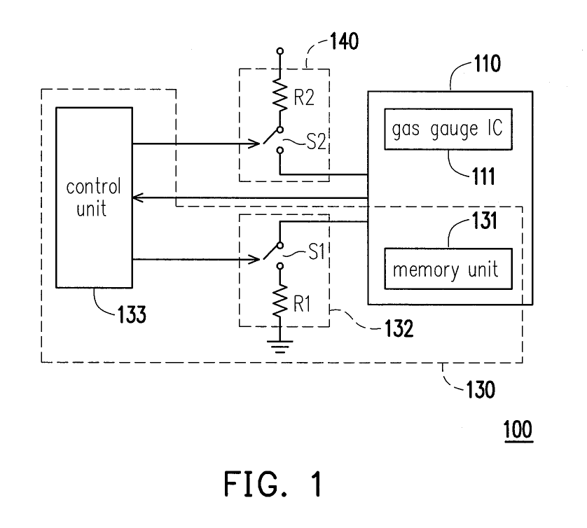

FIG. 1 is a schematic diagram showing the architecture of a portable electronic device in an embodiment of the invention. In the embodiment, the portable electronic device 100 is a notebook, which is not used to limit the scope of the invention. In FIG. 1, the portable electronic device 100 includes a smart battery 110, a protective circuit 130, and a charging unit 140. The smart battery 110 includes a gas gauge IC 111 and a memory unit 131. The gas gauge IC 111, the memory unit 131 and the battery cell (not shown) are assembled in the smart battery 110. The gas gauge IC 111 is used to measure the electric quantity of the smart battery 110, and a user can read the value measured by the gas gauge IC 111 through the portable electronic device 100 to know the electric quantity of the smart battery 110.

The protective circuit 130 is used to prevent the smart battery 110 from being damaged. In the embodiment of the invention, the protective circuit 130 includes a memory unit 131, a discharging unit 132 and a control unit 133. The memory unit 131 is disposed in the smart battery 110 to store at least one preset value. In the embodiment, the preset value can be defined by the user himself or herself and also can be set or adjusted by the user himself or herself through the portable electronic device 100. The discharging unit 132 and the control unit 133 are disposed in the portable electronic device 100. In the embodiment, the discharging unit 132 includes a resistor R1 and a switch S1. However, the circuit structure of the discharging unit 132 is not limited. In the embodiment, the discharging unit 132 is an additional discharging unit in the portable electronic device 100. When the discharging unit 132 discharges the smart battery, the normal operation of the portable electronic device 100 is not affected.

As shown in FIG. 1, the discharging unit 132 is coupled to the smart battery 110 as a discharging medium of the smart battery 110 when the smart battery 110 does not need to provide power for the portable electronic device 100 normally. That is, when the portable electronic device 100 is connected to an external power supply (not shown), the operational power supply of the portable electronic device 100 is provided by the external power supply. At that moment, the power supply path of the portable electronic device 100 is switched automatically, and the operational power supply is provided by the external power supply. The smart battery 110 does not need to provide power for the portable electronic device 100 normally. In the embodiment, when the portable electronic device 100 is connected to an external power supply (not shown), if the discharging conditions are met, the smart battery 110 is only discharged through the discharging unit 132.

In other words, in the embodiment, whether the smart battery 110 provides power for the portable electronic device 100 normally is determined according to whether the portable electronic device 100 is connected to the power adapter (not shown). For example, when the portable electronic device 100 is connected to a power adapter connected to an external power supply, the portable electronic device 100 directly uses the commercial power as an operational power supply. Therefore, the smart battery 110 does not need to provide power for the portable electronic device 100. On the contrary, when the portable electronic device 100 is not connected to the power adapter electrically connected to an external power supply, the smart battery 110 provides power for the portable electronic device 100 normally.

The control unit 133 is coupled to the memory unit 131 and the discharging unit 132, respectively. When the smart battery 110 does not need to provide power for the portable electronic device 100 normally (at that moment, the portable electronic device 100 is connected to the external power supply), the control unit 133 counts and updates the state of the preset value stored in the memory unit 131 every preset time. In addition, when the preset value (the counting value of the control unit 133) reaches a specific value, the control unit 133 controls the discharging unit 132 to discharge the smart battery 110 assembled in the portable electronic device 100 through the discharging unit 132.

For example, a user may set the initial state of the preset value to be “1111” and set the specific value to be “0001”, and the control unit 133 counts downward (“1111” minus the specific value). When the smart battery 110 does not need to provide power for the portable electronic device 100 normally, the control unit 133 counts and updates the state of the preset value every preset time. When the control unit 133 reads the preset value of the memory unit 131, it reads “1111” as the state of the preset value. At that moment, the control unit 133 counts downward. The preset value is updated to be “1110” from “1111”. Afterward, the control unit 133 stores the preset value “1110” to the memory unit 131 to be a basis of reading data in the memory unit 131 for the first time. After the next preset time, when the control unit 133 reads the data in the memory unit 131 for the second time, it reads “1110” as the state of the preset value and then the control unit 133 counts downward again. That is, the preset value is updated to be “1101” from “1110”. Afterward, the control unit 133 stores the preset value “1101” to the memory unit 131 as a basis of reading the memory unit 131 for the second time. Others are by parity of reasoning.

If the control unit 133 counts and updates the state of the preset value to the specific value “0001”, it means that during the time period of updating the preset value from “1111” to “0001”, the smart battery 110 does not provide power for the portable electronic device 100 normally. Then, the control unit 133 controls the switch S1 of the discharging unit 132 to be on, then the smart battery 110 is connected to the ground through the resistor R1. Thus, the smart battery is discharged. Therefore, in the embodiment, for the smart battery 110, the damage caused by being unused for providing power normally for a long time is prevented.

In the embodiment, the preset value, specific value and preset time for the control unit to count and update the preset value can be adjusted by the user according to the requirement. The counting way is not limited to be counting downward, and it also can be changed to be counting upward. Since the above description may be referred to, the way of counting upward is not described for concise purpose. Additionally, the preset time can be adjusted by the user according to the requirement. For example, the preset time may be set to be one minute or five minutes and so on. That is, the control unit 133 counts and updates the preset value every one minute or every five minutes. This is not used to limit the scope of the invention.

In addition, in discharging the smart battery, whether the smart battery is discharged completely is not limited. The user also can discharge the smart battery with 50% depth of discharge and so on. If the smart battery 110 is discharged completely, a battery learn process can be performed to make the feedback about electricity quantity from the gas gauge IC 111 more accurate.

If the smart battery 110 provides power for the portable electronic device 100 normally (the operational power supply of the portable electronic device 100 is provided by a smart battery 110), the control unit 133 stops counting and updating the state of the preset value and resets the preset value to restore the preset value to the initial state such as the “1111” above. Thus, the initial state is used as a start time when the smart battery 110 does not need to provide power for the portable electronic device normally.

As shown in FIG. 1, the charging unit 140 is coupled to the smart battery 110 and the control unit 133, and it is used as a charging medium when the smart battery 110 does not need to provide power for the portable electronic device 100 normally. In the embodiment, the charging unit 140 includes, for example, a resistor R2 and switch S2, and one end of the the resistor R2 is connected to a power adapter. However, the circuit structure of the charging unit 140 is not limited. When the smart battery 110 is charged through the charging unit 140, the control unit 133 stops counting and updating the state of the preset value, and it resets the preset value to restore the preset value to the initial state.

For example, when the smart battery 110 does not need to provide power for the portable electronic device 100 normally, the control unit 132 controls the switch S2 to be on. Thus, smart battery 110 is connected to the power adapter to charge the smart battery through the resistor R2. At the same time, the control unit 133 stops counting and updating the state of the preset value, and it resets the preset value to restore the preset value to the initial state.

In the embodiment, the control unit 133 is an embedded controller (EC). The memory unit 131 is a nonvolitile memory, and it includes, for example, at least an electrically erasable programmable read only memory (EEPROM) or a flash memory.

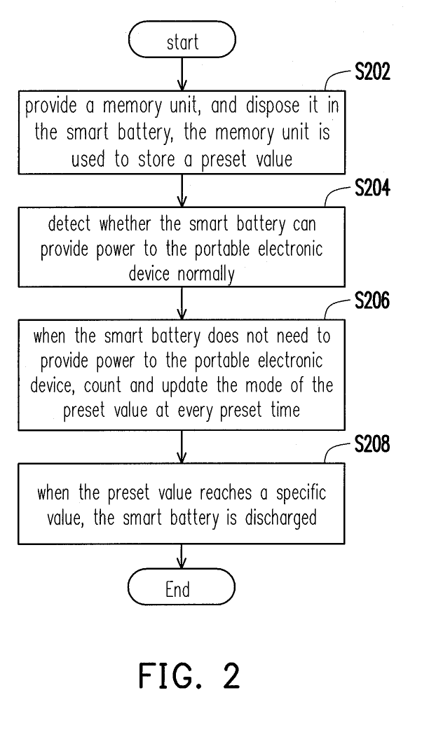

According to the embodiment above, a protection method for preventing a smart battery from being damaged can be obtained. FIG. 2 is a flow chart showing the protection method for preventing the smart battery from being damaged in an embodiment of the invention. As shown in FIG. 2, in step 202, a memory unit is provided and disposed in the smart battery. The memory unit is used for storing a preset value. The initial state of the preset value can be a start time when the smart battery does not need to provide power for the portable electronic device normally.

In step S204, whether the smart battery provides power for the portable electronic device normally or not is detected. If the smart battery does not need to provide power for the portable electronic device normally, step S206 is performed. The control unit counts and updates the state of the preset value every preset time. The preset time can be adjusted according to the user himself or herself.

During the time that the control unit counts and updates the state of the preset value, when the preset value reaches a specific value, as shown in step S208, the smart battery is discharged.

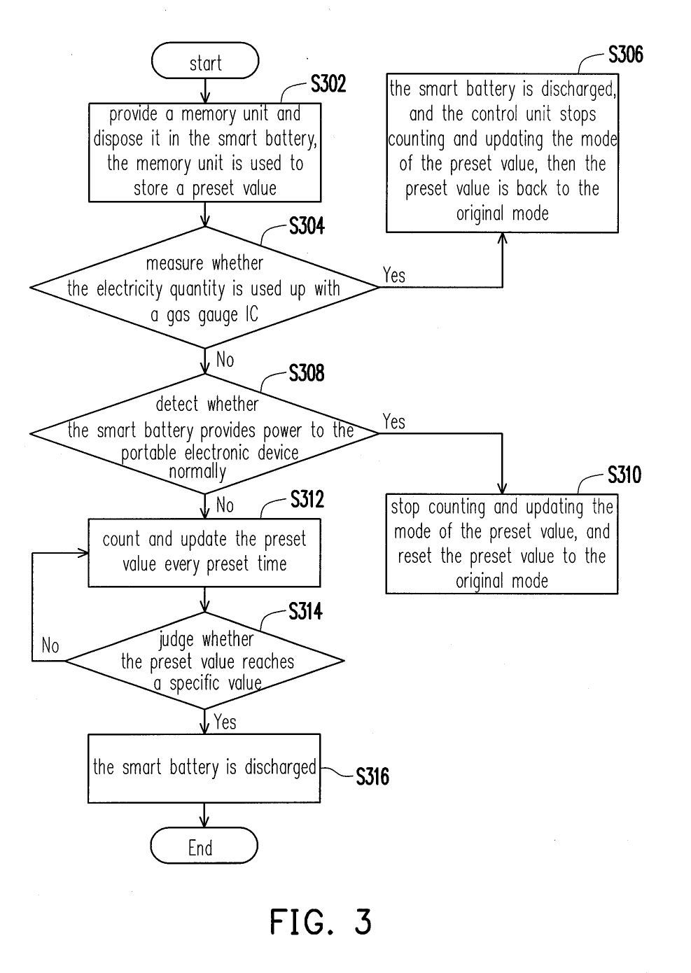

To describe every step of the protection method for preventing the smart battery from being damaged clearly, another embodiment is described hereinbelow to illustrate the detailed flowpath of the protection method in the invention. FIG. 3 is a flow chart showing the protective method for preventing the smart battery from being damaged in another embodiment of the invention. As shown in FIG. 3, a memory unit is provided in step S302, and it is disposed in the smart battery. The memory unit is used for storing a preset value.

Then, in step S304, a gas gauge IC is used to measure whether the electricity of the smart battery is exhaused. When the gas gauge IC measures the electricity of the smart battery to be exhaused, step S306 is performed. That is, the smart battery is charged, the control unit stops counting and updating the state of the preset value, and the control unit also resets the preset value to restore the preset value to the initial state.

In other words, when the gas gauge IC measures the electricity of the smart battery to be unexhausted, step S308 is performed. That is, whether the smart battery provides power for the portable electronic device is detected.

Afterward, when the control unit detects that the smart battery needs to provide power for the portable electronic device normally, as shown in step S310, the control unit stops counting and updating the state of the preset value, and it resets the preset value to restore the preset value to the initial state.

In other words, when it is detected that the smart battery does not need to provide power for the portable electronic device, as shown in step S312, the control unit counts and updates the state of the preset value every preset time.

Then, in step S314, whether the preset value reaches a specific value is determined. When the preset value is confirmed to reach the specific value, as shown in step S316, the smart battery is discharged. Therefore, for the smart battery, the damage caused by being unused for a long time can be prevented.

In addition, if the determining result is that the preset value does not reach the specific value, step S312 is performed again. The control unit continues counting and updating the state of the preset value every preset time.

In the embodiment, the memory unit may be a nonvolatile memory such as an EEPROM or a flash memory. In addition, the portable electronic device is a notebook.

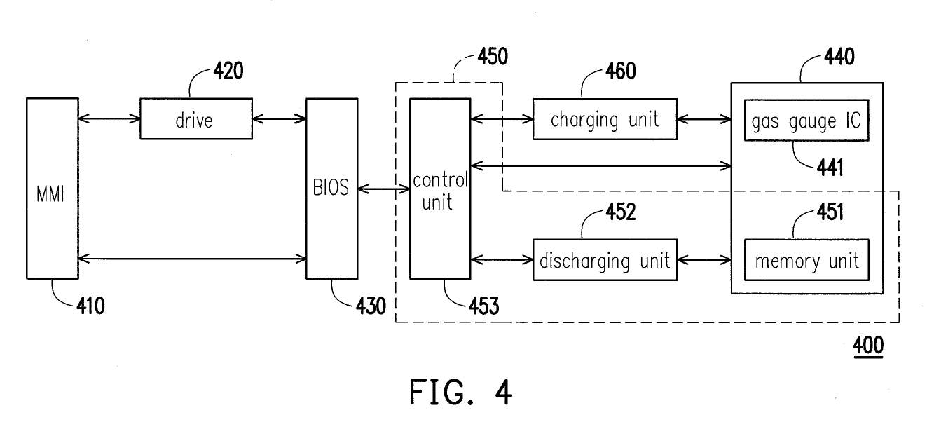

FIG. 4 is a schematic diagram of the architecture of a portable electronic device in another embodiment of the invention. As shown in FIG. 4, the portable electronic device 400 includes a man machine interface (MMI) 410, a driver 420, a basic input output system (BIOS) 430, a smart battery 440, a protective circuit 450 and a charging unit 460. In the embodiment, since the description for FIG. 1 may be referred to, the operating modes of the smart battery 440, the protective circuit 450 and the charging unit 460 are not described for concise purpose.

As shown in FIG. 4, in the embodiment, the smart battery, by itself, can prevent from being damaged, and a conventional technology is also remained. A user can control the control unit 453 to perform the battery learn process through the MMI 410 and the BIOS 430. That is, in the embodiment, the portable electronic device 400 is installed with the driver 420. Thus, even though the portable electronic device 400 finishes booting and loads the Windows operating system, the BIOS 430 also can be controlled to perform the battery learn process by executing the driver 420. That is, the BIOS 430 can control the control unit 453 and further control the discharging unit 452 to discharge the smart battery 440 through the discharging unit 452.

In other words, in the embodiment, the user can operate the BIOS 430 through the driver 420 of the operating system 420 via the MMI 410 to control the control unit 453 to perform the battery learn process. Since the user does not need to enter the BIOS 430, when performing the battery learn process, the portable electronic device still can be used. Thus, the time for waiting for the battery learn of the smart battery 440 greatly decreases.

To sum up, the protective circuit including the memory unit, the discharging unit and the control unit in the embodiment of the invention can protect the smart battery when the smart battery is not used to provide power for a long time. That is, when the smart battery does not provide power for the portable electronic device (notebook), the control unit counts and updates the preset value stored in the memory unit every preset time. When the control unit counts and updates the preset value to a specific value, it automatically controls the discharging unit to discharge the smart battery through the discharging unit. Thus, in the invention, for the smart battery, the damage caused by being unused for a long time can be prevented. In addition, the smart battery in the invention is discharged through the discharging unit instead of using the portable electronic device as a discharging medium. Therefore, the user can still use the portable electronic device, which is convenient.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A protective circuit for preventing a smart battery being damaged, comprising:
a memory unit, disposed in the smart battery, for storing a preset value;
a discharging unit disposed in a portable electronic device and coupled to the smart battery; and
a control unit, coupled with the memory unit and the discharging unit, disposed in the portable electronic device, when the portable electronic device is connected to an external power supply, the control unit counts and updates the state of the preset value every preset time, and when the preset value reaches a specific value, the control unit controls the discharging unit to discharge the smart battery through the discharging unit.

2. The protective circuit according to claim 1, wherein when the portable electronic device is connected to the external power supply, an operational power supply of the portable electronic device is provided by the external power supply.

3. The protective circuit according to claim 1, wherein when the operational power supply of the portable electronic device is provided by the smart battery, the control unit stops counting and updating the state of the preset value and resets the preset value of the memory unit.

4. The protective circuit according to claim 1, wherein when the preset value reaches the specific value, and the portable electronic device runs a Windows operating system, the control unit controls the discharging unit to discharge the smart battery through the discharging unit.

5. A portable electronic device comprising:
a smart battery; and
a protective circuit including:
a memory unit, disposed in the smart battery, for storing a preset value;
a discharging unit disposed in the portable electronic device and coupled with the smart battery; and
a control unit, coupled with the memory unit and the discharging unit, disposed in the portable electronic device, when the portable electronic device is connected to an external power supply, the control unit counts and updates the state of the preset value every preset time, and when the preset value reaches a specific value, the control unit controls the discharging unit to discharge the smart battery through the discharging unit.

6. The portable electronic device according to claim 5, wherein when an operational power supply of the portable electronic device is provided by the smart battery, the control unit stops counting and updating the state of the preset value and resets the preset value.

7. The portable electronic device according to claim 5, further comprising:
a charging unit, disposed in the portable electronic device, coupled with the smart battery and the control unit, wherein when the portable electronic device is connected to the external power supply, and the charging unit charges the smart battery, the control unit stops counting and updating the state of the preset value and resets the preset value.

8. The portable electronic device according to claim 5, wherein the smart battery further comprises a gas gauge integrated circuit (IC) for measuring the electric quantity of the smart battery.

9. The portable electronic device according to claim 5, wherein when the portable electronic device is connected to the external power supply, the operational power supply of the portable electronic device is provided by the external power supply.

10. The portable electronic device according to claim 5, wherein when the preset value reaches the specific value, and the portable electronic device runs a Windows operating system, the control unit controls the discharging unit to discharge the smart battery through the discharging unit.

11. A protection method for preventing a smart battery from being damaged, the protection method comprising the steps of:
detecting whether an operational power supply of a portable electronic device is provided by an external power supply;
when the operational power supply of the portable electronic device is provided by the external power supply, counting and updating the state of a preset value in a memory unit of the smart battery every preset time; and
when the preset value reaches a specific value, discharging the smart battery.

12. The protection method according to claim 11, further comprising:
if the preset value does not reach the specific value, continuing counting and updating the preset value every preset time.

13. The protection method according to claim 11, further comprising: when the operational power supply of the portable electronic device is provided by the smart battery, stopping counting and updating the preset value.

14. The protection method according to claim 11, wherein when the preset value reaches the specific value, and the portable electronic device runs a Windows operating system, controlling the smart battery to be discharged.
